(19) United States
(12) Patent Application Publication
(10) Pub. No.: US 2022/0289243 A1
(43) Pub. Date: Sep. 15, 2022

(54) REAL TIME INTEGRITY CHECK OF GPU ACCELERATED NEURAL NETWORK

(71) Applicant: Motional AD LLC, Boston, MA (US)

(72) Inventor: Stephen L. Thomas, Cheswick, PA (US)

(21) Appl. No.: 17/695,513

(22) Filed: Mar. 15, 2022

Related U.S. Application Data
(60) Provisional application No. 63/161,322, filed on Mar. 15, 2021.

(51) Int. Cl. B60W 60/00; G06T 1/20

(52) U.S. Cl. CPC B60W 60/0015; G06T 1/20; B60W 2420/42

(57) ABSTRACT

Among other things, techniques are described for randomized real time integrity check of a GPU accelerated neural network. A method includes generating an input data stream, wherein the input data stream comprises sensor data associated with an autonomous vehicle. The method includes inserting input test data into the input data stream during operation of the autonomous vehicle, wherein the input data stream is input to a neural network accelerated by a graphics processing unit. An output data stream from the neural network with a predetermined output corresponding to the input data stream is compared, and an integrity of the neural network accelerated by a graphics processing unit is verified.

### CROSS REFERENCE TO RELATED APPLICATIONS

This application claims priority to U.S. Provisional Patent Application No. 63/161,322, filed Mar. 15, 2021, the entire contents of which are incorporated herein by reference.

### FIELD OF THE INVENTION

This description relates to randomized real time integrity checks of GPU accelerated neural networks.

### BACKGROUND

A vehicle (e.g., an autonomous vehicle) is operable along a path in an environment from a starting location to a final location while avoiding objects and obeying rules of the road. Various data points associated with traversing the path are calculated. In some embodiments, a neural network computes these data points. The runtime of a neural network can be accelerated using hardware for at least a portion of the calculations.

### BRIEF DESCRIPTION OF THE DRAWINGS

FIG. 1 shows an example of an autonomous vehicle (AV) having autonomous capability.

FIG. 2 shows an example “cloud” computing environment.

FIG. 3 shows a computer system.

FIG. 4 shows an example architecture for an AV.

FIG. 5 shows an example of inputs and outputs that can be used by a perception system.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning system.

FIG. 10 shows a directed graph used in path planning.

FIG. 11 shows a block diagram of the inputs and outputs of a control system.

FIG. 12 shows a block diagram of the inputs, outputs, and components of a controller.

FIG. 13 is a block diagram of a real time integrity check of a GPU accelerated neural network.

FIG. 14 is a block diagram of a testing in a GPU accelerated neural network.

FIG. 15 is a block diagram of a process that enables a real time integrity check of a GPU accelerated neural network.

### DETAILED DESCRIPTION

In the following description, for the purposes of explanation, numerous specific details are set forth in order to provide a thorough understanding of the present disclosure. It will be apparent, however, that the present disclosure can be practiced without these specific details. In other instances, well-known structures and devices are shown in block diagram form in order to avoid unnecessarily obscuring the present disclosure.

In the drawings, specific arrangements or orderings of schematic elements, such as those representing devices, modules, systems, instruction blocks, and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. AV Architecture

4. AV Inputs

5. AV Planning

6. AV Control

7. Real Time Integrity Check of a GPU Accelerated Neural Network

### General Overview

In some embodiments, a real time integrity check of a GPU accelerated neural network is provided. An input data stream is generated. The input data stream comprises sensor data associated with an autonomous vehicle. Input test data is inserted into the input data stream during operation of the autonomous vehicle. The input data stream is input to a neural network accelerated by a graphics processing unit, and an output data stream from the neural network is compared with a predetermined output corresponding to the input data stream. An integrity of the neural network accelerated by a graphics processing unit is verified, wherein a fault is issued in response to a mismatch between the output data stream and the predetermined output.

Some of the advantages of these techniques include a practical safety ASIL certification technique for a DNN/GPU subsystem. The present techniques ensure high coverage of test cases used to enable randomized real time integrity check of a graphics processing unit (GPU) accelerated neural network. The present techniques enable a path for safety certified hardware.

### System Overview

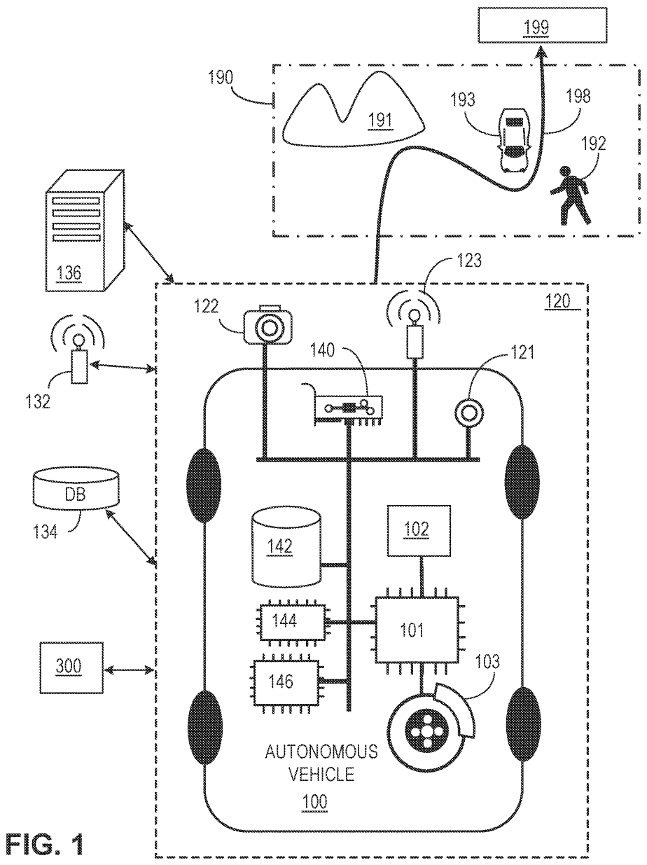

FIG. 1 shows an example of an AV 100 having autonomous capability.

As used herein, the term “autonomous capability” refers to a function, feature, or facility that enables a vehicle to be partially or fully operated without real-time human intervention, including without limitation fully AVs, highly AVs, and conditionally AVs.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In some embodiments, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In some embodiments, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

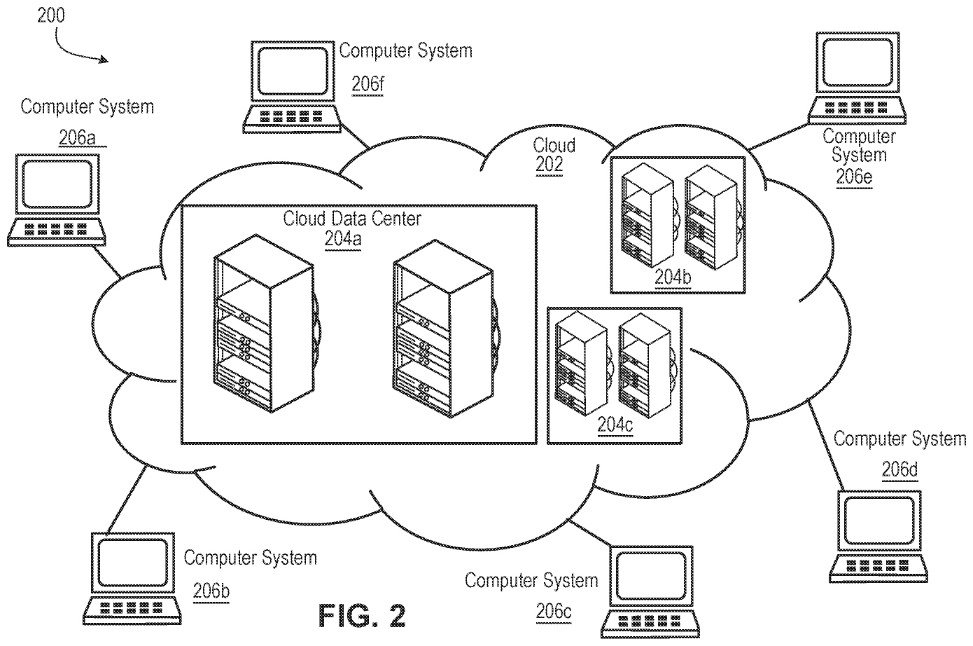

As used herein, an AV system refers to the AV along with the array of hardware, software, stored data, and data generated in real-time that supports the operation of the AV. In some embodiments, the AV system is incorporated within the AV. In some embodiments, the AV system is spread across several locations. For example, some of the software of the AV system is implemented on a cloud computing environment similar to cloud computing environment 200 described below with respect to FIG. 2.

In general, this document describes technologies applicable to any vehicles that have one or more autonomous capabilities including fully AVs, highly AVs, and conditionally AVs, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially AVs and driver assisted vehicles, such as so-called Level 2 and Level 1 vehicles (see SAE International's standard J3016: Taxonomy and Definitions for Terms Related to On-Road Motor Vehicle Automated Driving Systems). In some embodiments, one or more of the Level 1, 2, 3, 4 and 5 vehicle systems can automate certain vehicle operations (e.g., steering, braking, and using maps) under certain operating conditions based on processing of sensor inputs. The technologies described in this document can benefit vehicles in any levels, ranging from fully AVs to human-operated vehicles.

AVs have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

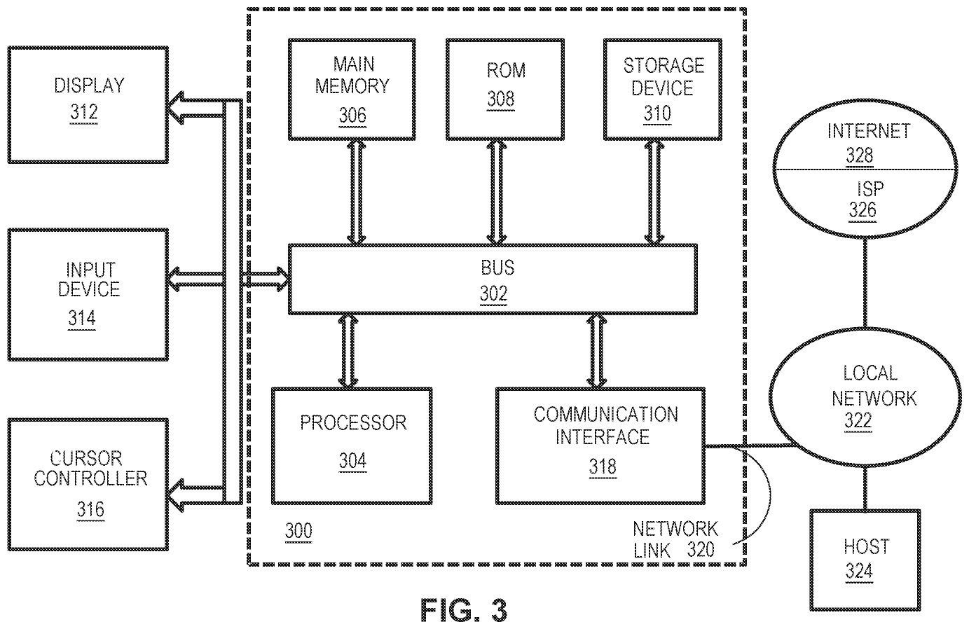

In some embodiments, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In some embodiments, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In some embodiments, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In some embodiments, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In some embodiments, the AV system 120 includes a data storage unit 142 and memory 144 for storing machine instructions associated with computer processors 146 or data collected by sensors 121. In some embodiments, the data storage unit 142 is similar to the ROM 308 or storage device 310 described below in relation to FIG. 3. In some embodiments, memory 144 is similar to the main memory 306 described below. In some embodiments, the data storage unit 142 and memory 144 store historical, real-time, and/or predictive information about the environment 190. In some embodiments, the stored information includes maps, driving performance, traffic congestion updates or weather conditions. In some embodiments, data relating to the environment 190 is transmitted to the vehicle 100 via a communications channel from a remotely located database 134.

In some embodiments, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In some embodiments, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among AVs.

In some embodiments, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In some embodiments, the remotely located database 134 is embedded in a cloud computing environment 200 as described in FIG. 2. The communication devices 140 transmit data collected from sensors 121 or other data related to the operation of vehicle 100 to the remotely located database 134. In some embodiments, communication devices 140 transmit information that relates to teleoperations to the vehicle 100. In some embodiments, the vehicle 100 communicates with other remote (e.g., “cloud”) servers 136.

In some embodiments, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In some embodiments, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In some embodiments, the AV system 120 includes computer peripherals 132 coupled to computer processors 146 for providing information and alerts to, and receiving input from, a user (e.g., an occupant or a remote user) of the vehicle 100. In some embodiments, peripherals 132 are similar to the display 312, input device 314, and cursor controller 316 discussed below in reference to FIG. 3. The coupling is wireless or wired. Any two or more of the interface devices can be integrated into a single device.

In some embodiments, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In some embodiments, the privacy level specifies particular information associated with a passenger that is deleted once the ride is completed. In some embodiments, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In some embodiments, a privacy level identifies specific information to be stored or shared. In some embodiments, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In some embodiments, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementation, servers in zones, rooms, racks, and/or rows are arranged into groups based on physical infrastructure requirements of the datacenter facility, which include power, energy, thermal, heat, and/or other requirements. In some embodiments, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In some embodiments, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In some embodiments, the computing systems 206a-f are implemented as various computing devices, for example servers, desktops, laptops, tablet, smartphones, Internet of Things (IoT) devices, AVs (including, cars, drones, shuttles, trains, buses, etc.) and consumer electronics. In some embodiments, the computing systems 206a-f are implemented in or as a part of other systems.

FIG. 3 shows a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In some embodiments, the computer system 300 includes a bus 302 or other communication mechanism for communicating information, and a processor 304 coupled with a bus 302 for processing information. The processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In some embodiments, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In some embodiments, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In some embodiments, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In some embodiments, the network 320 contains the cloud 202 or a part of the cloud 202 described above.

The computer system 300 sends messages and receives data, including program code, through the network(s), the network link 320, and the communication interface 318. In some embodiments, the computer system 300 receives code for processing. The received code is executed by the processor 304 as it is received, and/or stored in storage device 310, or other non-volatile storage for later execution.

### AV Architecture

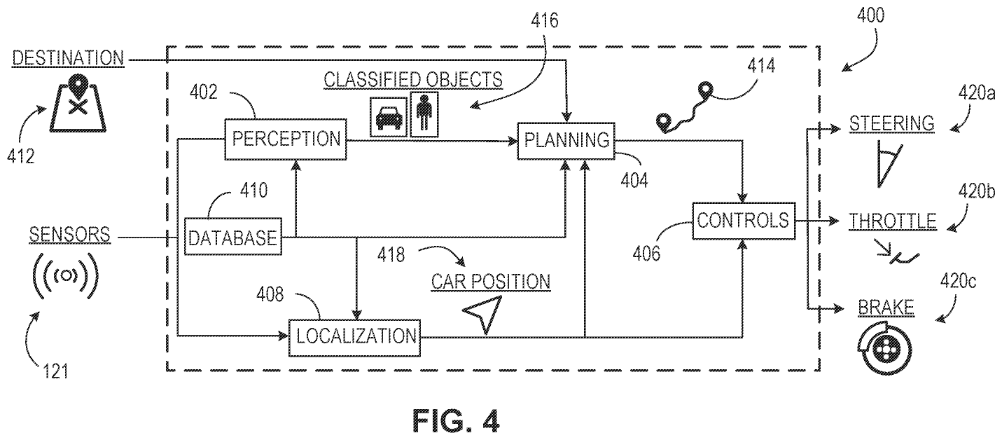

FIG. 4 shows an example architecture 400 for an AV (e.g., the vehicle 100 shown in FIG. 1). The architecture 400 includes a perception system 402 (sometimes referred to as a perception circuit), a planning system 404 (sometimes referred to as a planning circuit), a control system 406 (sometimes referred to as a control circuit), a localization system 408 (sometimes referred to as a localization circuit), and a database system 410 (sometimes referred to as a database circuit). Each system plays a role in the operation of the vehicle 100. Together, the systems 402, 404, 406, 408, and 410 can be part of the AV system 120 shown in FIG. 1. In some embodiments, any of the systems 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the systems 402, 404, 406, 408, and 410 is sometimes referred to as a processing circuit (e.g., computer hardware, computer software, or a combination of the two). A combination of any or all of the systems 402, 404, 406, 408, and 410 is also an example of a processing circuit.

In use, the planning system 404 receives data representing a destination 412 and determines data representing a trajectory 414 (sometimes referred to as a route) that can be traveled by the vehicle 100 to reach (e.g., arrive at) the destination 412. In order for the planning system 404 to determine the data representing the trajectory 414, the planning system 404 receives data from the perception system 402, the localization system 408, and the database system 410.

The perception system 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning system 404.

The planning system 404 also receives data representing the AV position 418 from the localization system 408. The localization system 408 determines the AV position by using data from the sensors 121 and data from the database system 410 (e.g., a geographic data) to calculate a position. For example, the localization system 408 uses data from a GNSS (Global Navigation Satellite System) sensor and geographic data to calculate a longitude and latitude of the AV. In some embodiments, data used by the localization system 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In some embodiments, the high-precision maps are constructed by adding data through automatic or manual annotation to low-precision maps.

The control system 406 receives the data representing the trajectory 414 and the data representing the AV position 418 and operates the control functions 420a-c (e.g., steering, throttling, braking, ignition) of the AV in a manner that will cause the vehicle 100 to travel the trajectory 414 to the destination 412. For example, if the trajectory 414 includes a left turn, the control system 406 will operate the control functions 420a-c in a manner such that the steering angle of the steering function will cause the vehicle 100 to turn left and the throttling and braking will cause the vehicle 100 to pause and wait for passing pedestrians or vehicles before the turn is made.

### AV Inputs

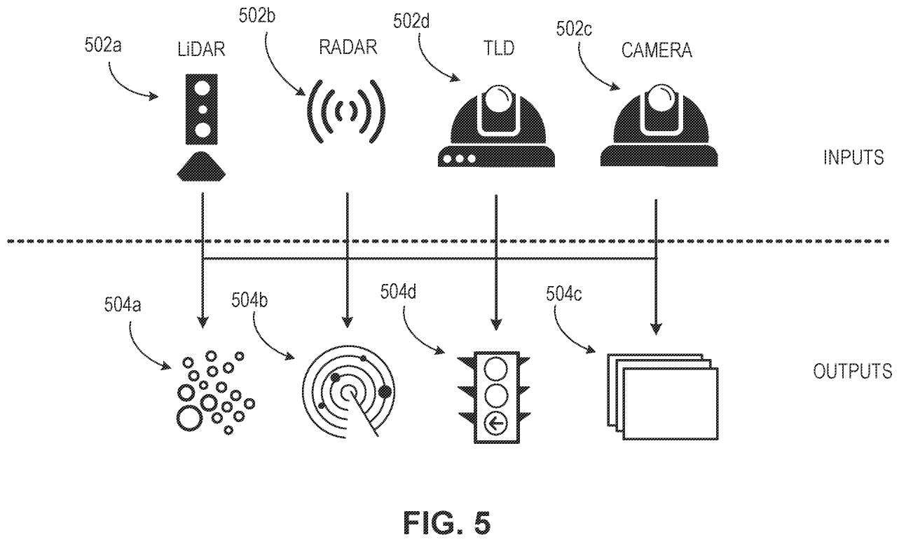

FIG. 5 shows an example of inputs 502a-d (e.g., sensors 121 shown in FIG. 1) and outputs 504a-d (e.g., sensor data) that is used by the perception system 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as a point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system is about 120 degrees or more.

In some embodiments, outputs 504a-d are combined using a sensor fusion technique. Thus, either the individual outputs 504a-d are provided to other systems of the vehicle 100 (e.g., provided to a planning system 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

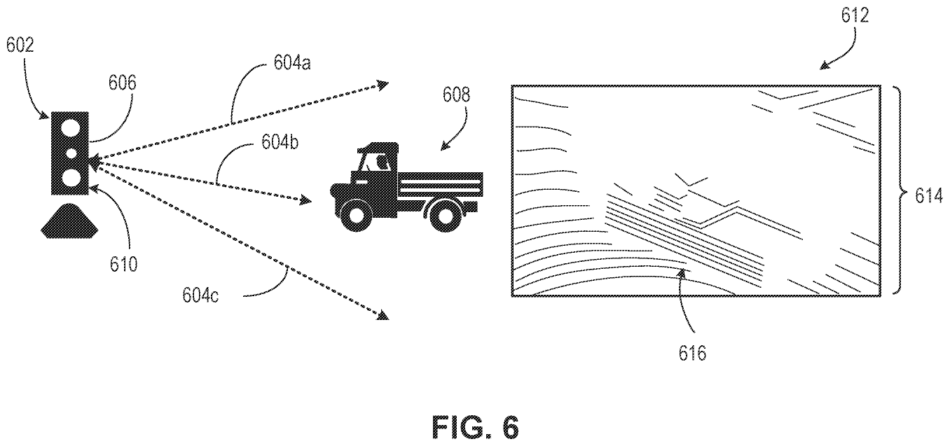

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In some embodiments, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

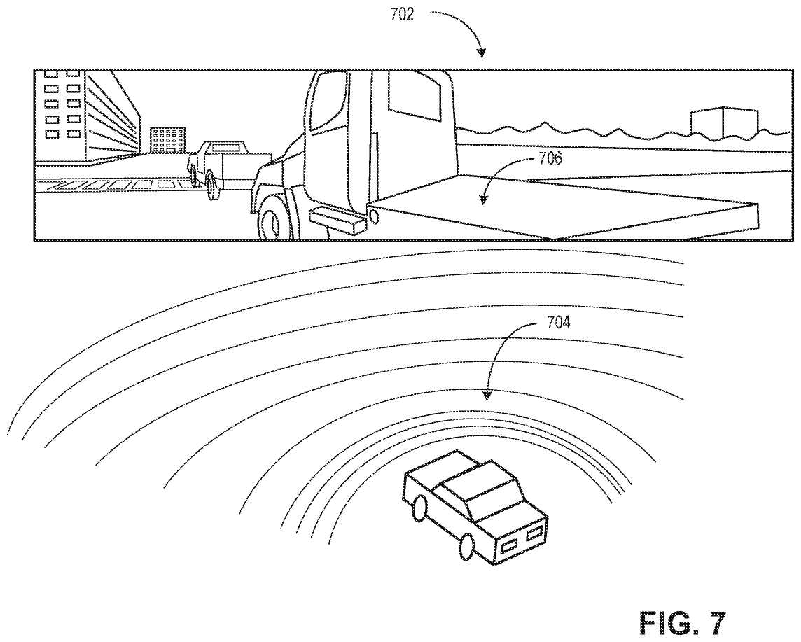

FIG. 7 shows the LiDAR system 602 in operation. In the scenario shown in this figure, the vehicle 100 receives both camera system output 504c in the form of an image 702 and LiDAR system output 504a in the form of LiDAR data points 704. In use, the data processing systems of the vehicle 100 compares the image 702 to the data points 704. In particular, a physical object 706 identified in the image 702 is also identified among the data points 704. In this way, the vehicle 100 perceives the boundaries of the physical object based on the contour and density of the data points 704.

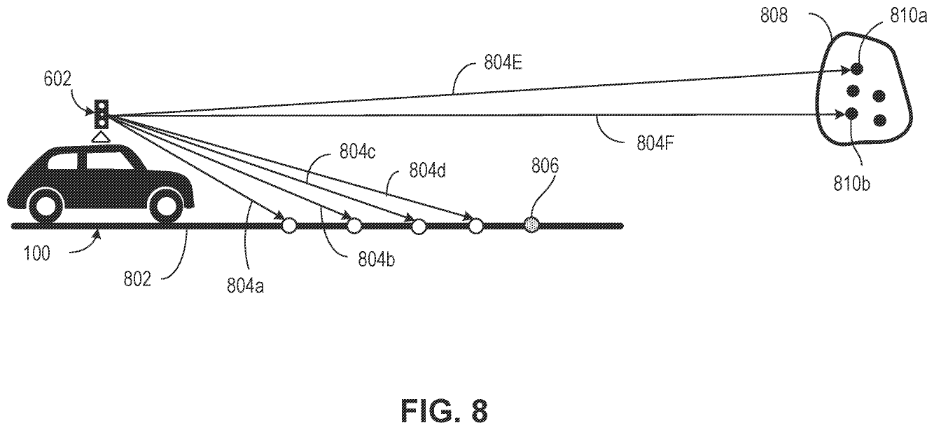

FIG. 8 shows the operation of the LiDAR system 602 in additional detail. As described above, the vehicle 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the vehicle 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the vehicle 100 can determine that the object 808 is present.

### Path Planning

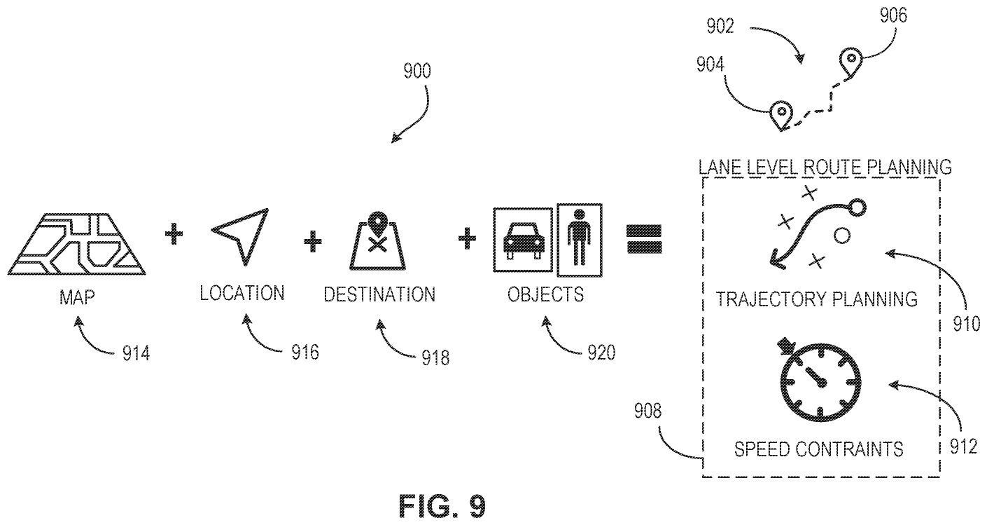

FIG. 9 shows a block diagram 900 of the relationships between inputs and outputs of a planning system 404 (e.g., as shown in FIG. 4). In general, the output of a planning system 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the vehicle 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to the route 902, a planning system also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the vehicle 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the vehicle 100 to a travel speed slower than an expected speed, e.g., a speed based on speed limit data for the segment.

In some embodiments, the inputs to the planning system 404 includes database data 914 (e.g., from the database system 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception system 402 as shown in FIG. 4). In some embodiments, the database data 914 includes rules used in planning. Rules are specified using a formal language, e.g., using Boolean logic. In any given situation encountered by the vehicle 100, at least some of the rules will apply to the situation. A rule applies to a given situation if the rule has conditions that are met based on information available to the vehicle 100, e.g., information about the surrounding environment. Rules can have priority. For example, a rule that says, “if the road is a freeway, move to the leftmost lane” can have a lower priority than “if the exit is approaching within a mile, move to the rightmost lane.”

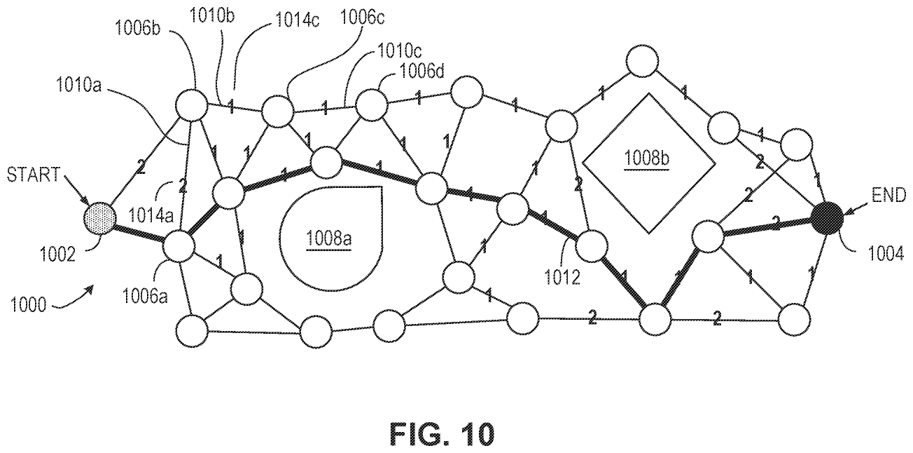

FIG. 10 shows a directed graph 1000 used in path planning, e.g., by the planning system 404 (FIG. 4). In general, a directed graph 1000 like the one shown in FIG. 10 is used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

In some embodiments, the directed graph 1000 has nodes 1006a-d representing different locations between the start point 1002 and the end point 1004 that could be occupied by a vehicle 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In some embodiments, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the vehicle 100.

The nodes 1006a-d are distinct from objects 1008a-b which cannot overlap with a node. In some embodiments, when granularity is low, the objects 1008a-b represent regions that cannot be traversed by automobile, e.g., areas that have no streets or roads. When granularity is high, the objects 1008a-b represent physical objects in the field of view of the vehicle 100, e.g., other automobiles, pedestrians, or other entities with which the vehicle 100 cannot share physical space. In some embodiments, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for a vehicle 100 to travel between one node 1006a and the other node 1006b, e.g., without having to travel to an intermediate node before arriving at the other node 1006b. (When we refer to a vehicle 100 traveling between nodes, we mean that the vehicle 100 travels between the two physical positions represented by the respective nodes.) The edges 1010a-c are often bidirectional, in the sense that a vehicle 100 travels from a first node to a second node, or from the second node to the first node. In some embodiments, edges 1010a-c are unidirectional, in the sense that an vehicle 100 can travel from a first node to a second node, however the vehicle 100 cannot travel from the second node to the first node. Edges 1010a-c are unidirectional when they represent, for example, one-way streets, individual lanes of a street, road, or highway, or other features that can only be traversed in one direction due to legal or physical constraints.

In some embodiments, the planning system 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the vehicle 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning system 404 identifies a path 1012 between the start point 1002 and end point 1004, the planning system 404 typically chooses a path optimized for cost, e.g., the path that has the least total cost when the individual costs of the edges are added together.

### AV Control

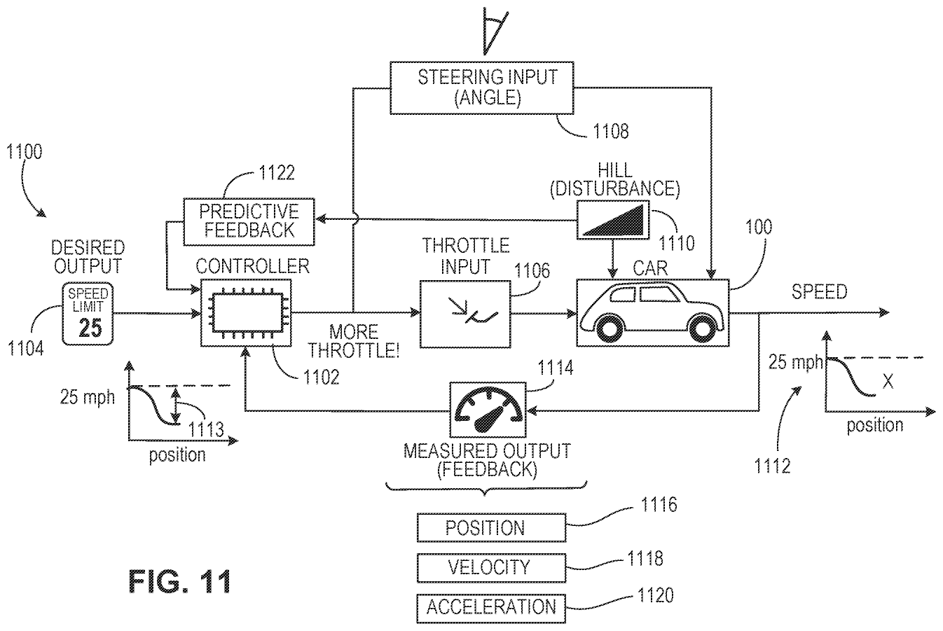

FIG. 11 shows a block diagram 1100 of the inputs and outputs of a control system 406 (e.g., as shown in FIG. 4). A control system operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the controller 1102 when the instructions are executed (e.g., by the one or more processors).

In some embodiments, the controller 1102 receives data representing a desired output 1104. The desired output 1104 typically includes a velocity, e.g., a speed and a heading. The desired output 1104 can be based on, for example, data received from a planning system 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an vehicle 100, e.g., by engaging the steering pedal, or engaging another throttle control, to achieve the desired output 1104. In some examples, the throttle input 1106 also includes data usable to engage the brake (e.g., deceleration control) of the vehicle 100. The steering input 1108 represents a steering angle, e.g., the angle at which the steering control (e.g., steering wheel, steering angle actuator, or other functionality for controlling steering angle) of the AV should be positioned to achieve the desired output 1104.

In some embodiments, the controller 1102 receives feedback that is used in adjusting the inputs provided to the throttle and steering. For example, if the vehicle 100 encounters a disturbance 1110, such as a hill, the measured speed 1112 of the vehicle 100 is lowered below the desired output speed. In some embodiments, any measured output 1114 is provided to the controller 1102 so that the necessary adjustments are performed, e.g., based on the differential 1113 between the measured speed and desired output. The measured output 1114 includes a measured position 1116, a measured velocity 1118 (including speed and heading), a measured acceleration 1120, and other outputs measurable by sensors of the vehicle 100.

In some embodiments, information about the disturbance 1110 is detected in advance, e.g., by a sensor such as a camera or LiDAR sensor, and provided to a predictive feedback system 1122. The predictive feedback system 1122 then provides information to the controller 1102 that the controller 1102 can use to adjust accordingly. For example, if the sensors of the vehicle 100 detect (“see”) a hill, this information can be used by the controller 1102 to prepare to engage the throttle at the appropriate time to avoid significant deceleration.

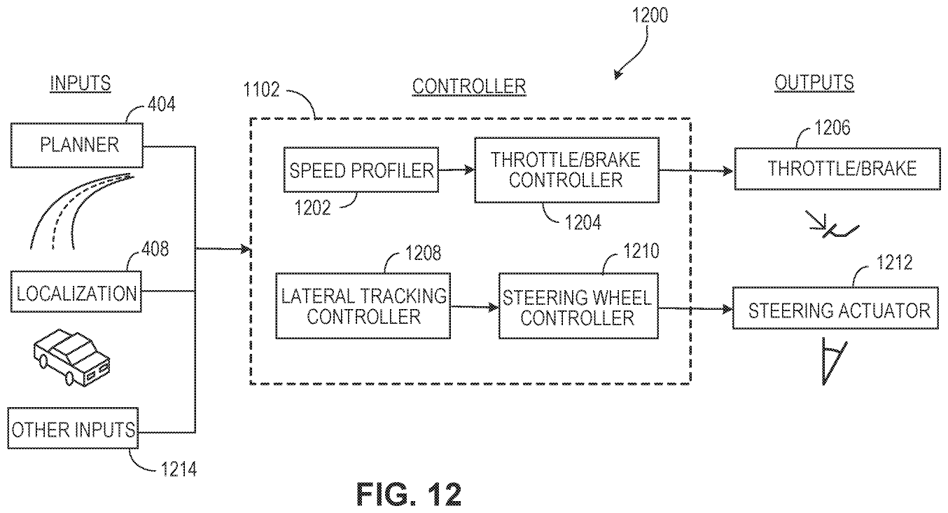

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning system 404 provides information used by the controller 1102, for example, to choose a heading when the vehicle 100 begins operation and to determine which road segment to traverse when the vehicle 100 reaches an intersection. A localization system 408 provides information to the controller 1102 describing the current location of the vehicle 100, for example, so that the controller 1102 can determine if the vehicle 100 is at a location expected based on the manner in which the throttle/brake 1206 and steering angle actuator 1212 are being controlled. In some embodiments, the controller 1102 receives information from other inputs 1214, e.g., information received from databases, computer networks, etc.

### Real Time Integrity Check of a GPU Accelerated Neural Network

In some embodiments, autonomous vehicles (e.g., vehicle 100 of FIG. 1), operate using deep neural networks (DNN) to recognize and react to the environment (e.g., environment 190 of FIG. 1)) in real time, allowing them to safely navigate. Data, such as sensor data (e.g., outputs 504a-d of FIG. 5), is processed by various systems of the vehicle using DNNs. For example, a perception system 402 (sometimes referred to as a perception circuit), planning system 404 (sometimes referred to as a planning circuit), a control system 406 (sometimes referred to as a control circuit), and a localization system 408 (sometimes referred to as a localization circuit) as shown in FIG. 4 use neural networks to process data. DNNs are often large in size and consume a relatively large portion of compute and memory resources.

Hardware accelerators are used to increase processing capabilities of DNNs. In examples, hardware accelerators include graphics processing units (GPUs), application specific integrated circuits (ASICs), field programmable gate arrays (FPGAs), and the like. In order for an autonomous vehicle to be considered sufficiently safe to operate on roadways among the general population, or for components or subsystems of the autonomous vehicle to be considered safe enough to be implemented in such autonomous vehicles, the systems and components must satisfy certain safety standards and regulations (e.g., according to Automotive Safety Integrity Level (ASIL) standards), among other examples. In some embodiments, the integrity of a DNN and GPU is verified while the DNN executes via a GPU in a safety critical system. Embodiments described herein verify the integrity of both the DNN software and GPU hardware by injecting test data into the system. In examples, the test data is static data from known test cases. In examples, the test data is dynamically generated data obtained during operation of a vehicle including the DNN and GPU.

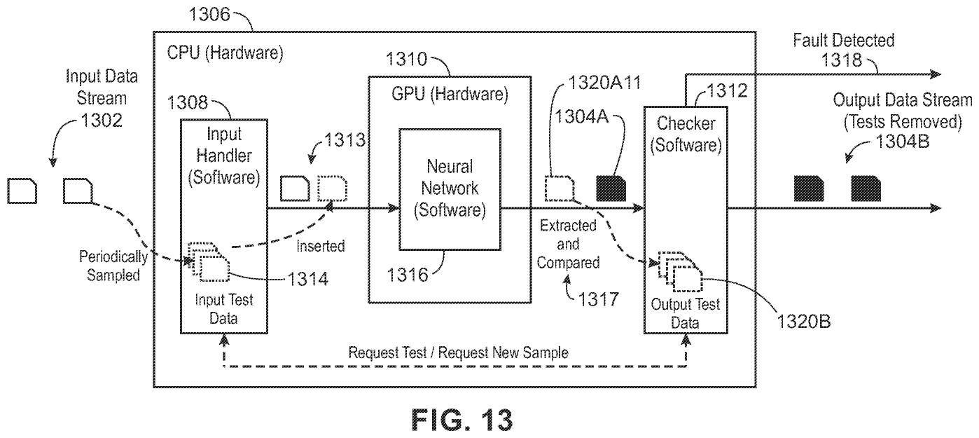

FIG. 13 is a block diagram of a process that enables a real-time integrity check of a neural network 1316. As illustrated in FIG. 13, the neural network 1316 is a GPU accelerated neural network. In some embodiments, the neural network 1316 is a DNN. In some embodiments, the neural network 1316 receives sensor data (e.g., outputs 504a-d of FIG. 5) as input and is operable according to any of the systems 402, 404, 406, 408, and 410 of FIG. 4.

In the example of FIG. 13, an input data stream 1302 represents actual input data. In embodiments, the actual input data is sensor data (e.g., outputs 504a-d of FIG. 5). An output data stream 1304 represents actual output data. In an example of a neural network implemented in a perception system (e.g., perception system 402 of FIG. 4), the actual output data is classified objects (e.g., classified objects 416 of FIG. 4). In an example of a neural network implemented in a planning system (e.g., planning system 404 of FIG. 4), the actual output data is a trajectory (e.g., trajectory 414 of FIG. 4). In an example of a neural network implemented in a control system (e.g., control system 406 of FIG. 4), the actual output data is control functions (e.g., control functions 420a-c of FIG. 4). In an example of a neural network implemented in a localization system (e.g., localization system 408 of FIG. 4), the actual output data is a vehicle position (e.g., AV position 418 of FIG. 4).

The input data stream 1302 is provided as input to the CPU 1306, and the CPU 1306 outputs the output data stream 1304. The CPU 1306 includes a number of software and hardware components. As illustrated in FIG. 13, the CPU 1306 includes an input handler 1308 and a checker 1312. Additionally, the CPU 1306 can offload processing tasks to a GPU 1310. Accordingly, for ease of illustration the GPU is shown as a component of the CPU 1306. However, the CPU 1306 and the GPU 1310 are independent hardware elements that are communicatively coupled and enable execution of the neural network 1316. The CPU 1306 is shown as including a particular number of components. However, the CPU can include any number of components.

In some embodiments, the input handler 1308 obtains the input data stream 1302. Additionally, the input handler 1308 is injected with input test data 1314. The checker 1312 provides input test data 1314 to the input handler 1308 and stores the corresponding predetermined output test data 1320B. In some embodiments, the predetermined output test data 1320B represents accurate, correct, or known good output data generated by an accurate, healthy hardware accelerated neural network in response to the test input data 1314. In some embodiments, the input data stream 1302 is periodically sampled to create dynamic test cases. The input handler outputs a data stream 1313 including the input data stream 1302 and input test data 1314.

The GPU 1310 obtains the data stream 1313 that includes the input data stream 1302 and the input test data 1314 as output by the input handler 1308. In some embodiments, the GPU hardware 1310 accelerates a neural network 1316 executing via the CPU 1306. The neural network 1316 outputs a data stream 1317. The data stream 1317 includes an output data stream 1304A and output test data 1320B. The output data stream 1304A is the output corresponding to the input data stream 1302, after processing by the neural network 1316. The output test data 1320A is the output corresponding to the input test data 1314, after processing by the neural network 1316.

The checker 1312 obtains the data stream 1317 and extracts the output data stream 1304A and the output test data 1320A. The checker 1312 compares the output test data 1320A to the predetermined output test data 1320B. In some embodiments, a fault is detected when the output test data 1320A does not correspond to the predetermined output test data 1320B. For example, when the output test data 1320A does not match the predetermined output test data 1320B, a fault is detected. When the output test data 1320A is outside of a predetermined threshold when compared to the predetermined output test data 1320B, a fault is detected. In response to the checker 1312 detecting a fault, the checker 1312 outputs a fault detected message 1318. The checker 1312 outputs the output data stream 1304B with tests removed. In some embodiments, the output data stream 1304B is the result of processing the input data stream 1302 at the neural network 1316. In examples, the output data stream 1304B corresponds to outputs 504a-d of FIG. 5, and are provided to other systems of the vehicle 100.

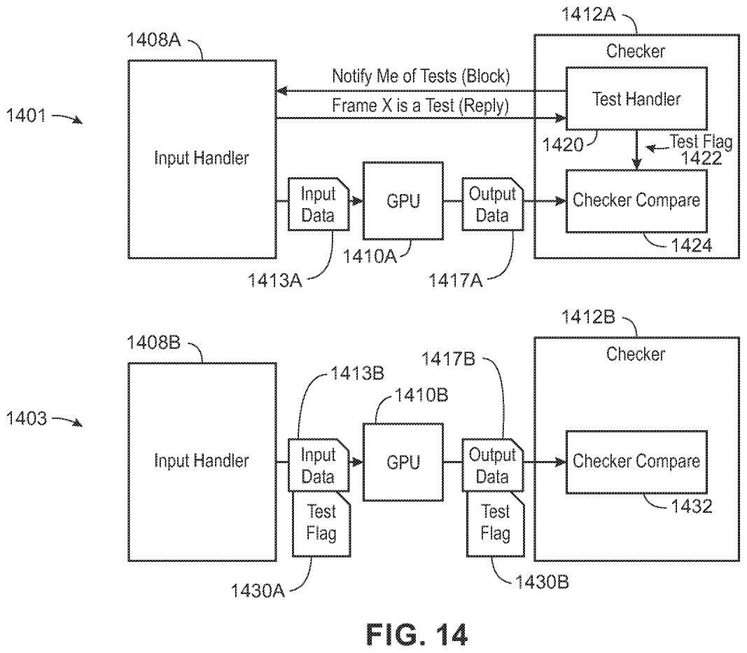

In some embodiments, the input handler 1308 and the checker 1312 are communicatively coupled, and the checker 1312 can request tests or request new samples. Exemplary testing is shown in FIG. 14. Referring again to FIG. 13, in some embodiments, the input handler 1308 stores one or more sets of static test input/output data and dynamic test input/output data. In an example, on request from the checker 1312, the input handler 1308 inserts static test data into the data stream 1313 for input to the neural network 1316. The neural network 1316 processes the data stream, and outputs a data stream 1317. In an example, on request from the checker 1312, the input handler 1308 samples the input data stream 1302 and generates dynamic test data, including input test data 1314 and output test data 1320B. The output test data 1320B corresponding to the dynamic test case is obtained by the checker 1312. In some embodiments, the checker 1312 stores one or more sets of static and dynamic test input/output data. In some embodiments, the checker 1312 periodically (e.g., every five seconds) requests a test from the input handler 1308. For example, the checker 1312 provides static input test data to the input handler 1308 at a relatively often time interval. In some embodiments, the checker 1312 periodically (e.g., every 10 minutes) requests that the input handler 1308 obtain new samples for dynamic test data generation. In response to the dynamic test case generation, the checker 1312 stores output test data for the samples. In examples, the checker 1312 requests dynamic test data generation from the input handler 1308 at a relatively longer time interval. Accordingly, the present techniques take advantage of the fact that most DNNs are deterministic, and the output is completely determined according to the input. Moreover, the present techniques use earlier (>10 min) outputs from the DNN/GPU that are very likely, but not certain, to be correct in dynamic test case generation.

In some embodiments, static test cases are selected from validation data and pre-loaded prior to deployment of the AV. Static test cases have a high confidence in correctness of output since the output is known a priori. A single test case gives limited coverage for testing, where testing does not cover a statistically significant number of test cases. In some embodiments, dynamic test cases are used. In an example, dynamic test cases are randomly selected in real-time operational data of vehicle, but used for test after a time delay of, for example, greater than 10 minutes. Dynamic test cases have a high confidence in the coverage of the test cases. In some embodiments, randomized test inputs give very high coverage, resulting in a statistically significant number of cases being used for verification. The correctness of outputs of dynamic test cases is not known for certain, but highly likely. In some embodiments, the combination of static and dynamic test cases gives very high test coverage (estimate >99%). Test coverage can be statistically estimated a priori by offline fault injection tests.

Generally, commercial hardware accelerators that are safety certified are unavailable. In an example, safety certified neural networks are unavailable and safety certified GPU hardware for x86 platforms is unavailable. For example, typical GPU hardware is not certified. In some embodiments, the present techniques enable integrity monitoring and safety certification for DNN/GPU subsystems. Moreover, the present techniques enable continual online verification. In examples, present techniques continually verify the correctness of a non-certified DNN/GPU output at runtime. The verification enables the overall architecture to meet Automotive Safety Integrity Level (ASIL) B requirements or higher. Additionally, the present techniques comply with ISO 21448: Safety of the Intended Functionality (SOTIF) by ensuring false positive and false negative interventions are balanced as provided by ISO 21448.

The Automotive Safety Integrity Level (ASIL) is a risk classification scheme defined by ISO 26262—“Functional Safety for Road Vehicles.” This is an adaptation of the Safety Integrity Level (SIL) used in the International Electrotechnical Commission (IEC) 61508 standard for the automotive industry. In some examples, in order for an autonomous vehicle to be considered sufficiently safe to operate on roadways among the general population, or for components or subsystems (e.g., CPU 1306, GPU 1310, neural network 1316) of the autonomous vehicle to be considered safe enough to be implemented in such autonomous vehicles, the systems and components must satisfy certain safety standards and regulations (e.g., according to ASIL standards), among other examples.

The ASIL is established by performing a risk analysis of a potential hazard by looking at the severity, exposure, and controllability of the vehicle operating scenario. The safety goal for that hazard in turn carries the ASIL levels. There are four ASIL levels (collectively referred to as ASILs) identified by the standard: ASIL A, ASIL B, ASIL C, ASIL D. The highest integrity is ASIL D, which dictates the highest integrity requirements and is a most stringent grade for safety integrity. The lowest integrity is ASIL A, which indicates a lowest level of integrity requirements and a lowest grade for safety integrity. In examples, the ASIL is accompanied by a quality management (QM) level. Generally, a QM level indicates that there is no need to implement additional risk reduction measures above and beyond the industry acceptable quality system.

In some embodiments, the input handler 1308 and checker 1312 are certified to ASIL B or higher, enabling ISO 26262 certification of the DNN/GPU subsystem. In some embodiments, dynamic test cases are verified by the checker 1312 before use by executing the neural network in a non-accelerated CPU. Accordingly, the present techniques enable a path to safety certification of the DNN/GPU subsystem. In some embodiments, the present techniques enable safety compliant neural networks. In some embodiments, the present techniques are an online test of the neural networks. The continual online verification verifies the correctness of a noncertified neural network and GPU output at runtime.

FIG. 14 is a block diagram of a testing in a DNN/GPU subsystem. In the example of FIG. 14, the operation of the DNN is accelerated by offloading DNN tasks to the GPU. The input handler 1408A and input handler 1408B are, for example, the input handler 1308 of FIG. 13. The GPU 1410A and GPU 1410B are, for example, the GPU 1310 of FIG. 13. Additionally, the checker 1412A and checker 1412B are, for example the checker 1312 of FIG. 13.

At reference number 1401, synchronous coordination between the input handler 1408A and checker 1412A is illustrated. In synchronous coordination, the input handler 1408A and checker 1412A exchange test notification messages via synchronous inter-process communication. As illustrated, the input handler 1408A provides input data 1413A (e.g., data stream 1313 of FIG. 13) for processing at a DNN accelerated by the GPU 1410A. The GPU generates output data 1417A (e.g., data stream 1317 of FIG. 13). A test handler 1420 of the checker 1412A sends a message to the input handler 1408A with a request for notification of tests (e.g., notify me of tests (block)). The input handler 1408 sends a message to the test handler 1420 with an identification of the test data within the input data 1413A (e.g., frame X is a test (reply)). The test handler 1420 generates a test flag 1422, and the checker compare 1424 uses the test flag to compare the output test data generated by the GPU 1410A to predetermined output test data. A mismatch between the output test data generated by the GPU 1410A and predetermined output test data at the checker causes the generation of a fault by the checker.

At reference number 1403, explicit tagging between the input handler 1408B and checker 1412B is illustrated. In explicit tagging, additional data is added to the input data to identify test cases. The additional data is passed through the DNN accelerated by the GPU 1410B to the output. In some embodiments, the additional data is a flag or other indicator. As illustrated, the input handler 1408B provides input data 1413B (e.g., data stream 1313 of FIG. 13) and a test flag 1430A for processing at a DNN accelerated by the GPU 1410B. The GPU generates output data 1417B (e.g., data stream 1317 of FIG. 13) with the test flag 1430B corresponding to the output data 1417B. The test flag 1430A is passed through the DNN accelerated by the GPU 1410B, resulting in test flag 1430B. The checker compare 1424 uses the test flag 1430B to compare the output test data generated by the GPU 1410B to predetermined output test data. A mismatch between the output test data generated by the GPU 1410B and predetermined output test data at the checker causes the generation of a fault by the checker.

Given an input, the present techniques compare the actual output to an expected, predetermined output. In examples, static test cases use sample inputs generated prior to deployment of the vehicle. The static test cases are processed by the GPU and the results are stored. The static test cases are loaded onto the AV at runtime. In some embodiments, test frames are periodically inserted into the data stream to ensure the neural network is still outputting correct data. In this manner, the neural network is continually tested with static test cases.

In examples, test cases are randomized through the generation of dynamic test data. In an example, the randomization may be based on an assumption that if a frame of data was processed after a time delay (e.g., 10 minutes) and no faults or collisions occurred, the neural network was likely healthy. The time delay enables the creation of new, random test cases. In some embodiments, after a period of time it is assumed that an older test case is a valid test case. Accordingly, in some embodiments the present techniques periodically sample real time operational data of the vehicle to create test cases. These test cases are used after a time delay according to the assumption that after a period of time with no collisions or detected faults, there is an assumption the older stored data is correct. The correctness of outputs is not known for certain, but highly likely. These randomized test inputs give very high coverage.

In some embodiments, static test cases are executed using a different set of hardware when compared to dynamic test cases. In examples, a stream of data is input to the GPU in real time. An input frame is sent to a second GPU or a second CPU (not the hardware under test). The second GPU or second CPU calculates an output based on the input, and the output is compared the output of the actual GPU accelerated neural network. In this manner, dynamic test cases are generated. According to the present techniques, if there is a fault or corruption in the neural network software or the GPU hardware, the fault is detected. This ultimately results in safety certification of the GPU hardware and the neural network software. In some embodiments, static test cases and dynamic test cases are both used. In some embodiments, when using both static test cases and dynamic test cases, the static test cases can ensure that test coverage is accurate as the correctness of the output is known a priori.

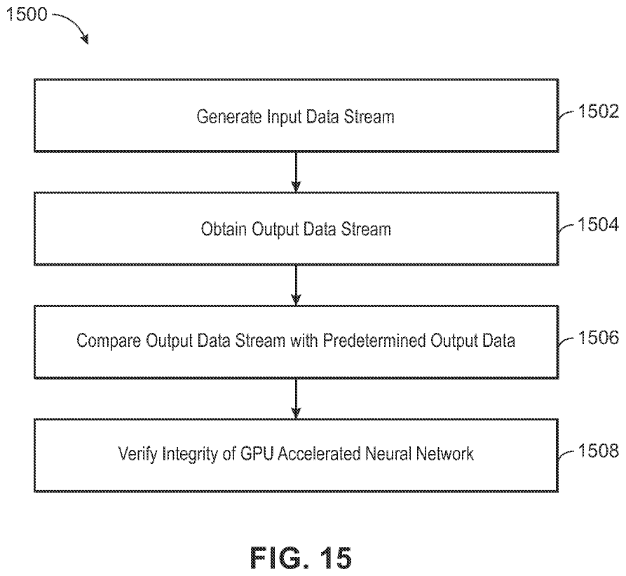

FIG. 15 is a process flow diagram of a process 1500 that enables a real time integrity check of a GPU accelerated neural network. The GPU accelerated network is as described with respect to FIGS. 13 and 14. At block 1502, an input data stream is generated. Input test data is inserted to the input data stream. In some embodiments, the input test data is static test data. In some embodiments, the input test data is dynamic test data.

At block 1504, output data is obtained from a neural network accelerated by a graphics processing unit. The neural network accelerated by the GPU processes the input data stream to generate the output data. In some embodiments, a CPU offloads neural network tasks to the GPU to accelerate execution of the neural network by providing additional computational resources. In some embodiments, execution of the neural network is accelerated using parallel processing of the GPU.

At block 1506, the output data is compared with predetermined output data. At block 1508, in response to a mismatch between the output data and the predetermined output data, a fault is generated. In response to a match between the output data and the predetermined output data, a no fault is generated. In this manner, the integrity of the neural network and GPU is determined in real-time.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
generating, using at least one processor, an input data stream, wherein the input data stream comprises sensor data associated with an autonomous vehicle;
inserting, using at least one processor, input test data into the input data stream during operation of the autonomous vehicle, wherein the input data stream is input to a neural network accelerated by a graphics processing unit;
comparing, using at least one processor, an output data stream from the neural network with a predetermined output corresponding to the input data stream; and
verifying, using the at least one processor, an integrity of the neural network accelerated by a graphics processing unit, wherein a fault is issued in response to a mismatch between the output data stream and the predetermined output.

2. The method of claim 1, wherein input test data inserted into the input data stream during operation of the autonomous vehicle is static test data generated prior to operation of the autonomous vehicle.

3. The method of claim 1, wherein input test data inserted into the input data stream during operation of the autonomous vehicle is dynamic test data generated during operation of the autonomous vehicle.

4. The method of claim 1, wherein inserting input test data into the input data stream during operation of the autonomous vehicle comprises synchronous coordination.

5. The method of claim 1, wherein inserting input test data into the input data stream during operation of the autonomous vehicle comprises explicit tagging.

6. The method of claim 1, wherein input test data is insert into the input data stream during operation of the autonomous vehicle at predetermined time intervals.

7. The method of claim 1, wherein the neural network accelerated by a graphics processing unit is certified at an Automotive Safety Integrity Level.

8. A non-transitory computer-readable storage medium comprising at least one program for execution by at least one processor of a first device, the at least one program including instructions which, when executed by the at least one processor, carry out a method comprising:
generating an input data stream, wherein the input data stream comprises sensor data associated with an autonomous vehicle;
inserting input test data into the input data stream during operation of the autonomous vehicle, wherein the input data stream and input test data are input to a neural network accelerated by a graphics processing unit;
comparing an output data stream from the neural network with a predetermined output corresponding to the input data stream; and
verifying an integrity of the neural network accelerated by a graphics processing unit, wherein a fault is issued in response to a mismatch between the output data stream and the predetermined output.

9. The non-transitory computer readable storage medium of claim 8, wherein input test data inserted into the input data stream during operation of the autonomous vehicle is static test data generated prior to operation of the autonomous vehicle.

10. The non-transitory computer readable storage medium of claim 8, wherein input test data inserted into the input data stream during operation of the autonomous vehicle is dynamic test data generated during operation of the autonomous vehicle.

11. The non-transitory computer readable storage medium of claim 8, wherein inserting input test data into the input data stream during operation of the autonomous vehicle comprises synchronous coordination.

12. The non-transitory computer readable storage medium of claim 8, wherein inserting input test data into the input data stream during operation of the autonomous vehicle comprises explicit tagging.

13. The non-transitory computer readable storage medium of claim 8, wherein input test data is insert into the input data stream during operation of the autonomous vehicle at predetermined time intervals.

14. The non-transitory computer readable storage medium of claim 8, wherein the neural network accelerated by a graphics processing unit is certified at an Automotive Safety Integrity Level.

15. A vehicle, comprising:
at least one computer-readable medium storing computer-executable instructions;
at least one processor communicatively coupled the at least one computer-readable medium and configured to execute the computer executable instructions, the execution carrying out operations including:
generating an input data stream, wherein the input data stream comprises sensor data associated with the vehicle;
inserting input test data into the input data stream during operation of the vehicle, wherein the input data stream and the input test data are input to a neural network accelerated by a graphics processing unit;
comparing an output data stream from the neural network with a predetermined output corresponding to the input data stream; and
verifying an integrity of the neural network accelerated by a graphics processing unit, wherein a fault is issued in response to a mismatch between the output data stream and the predetermined output.

16. The vehicle of claim 15, wherein input test data inserted into the input data stream during operation of the vehicle is static test data generated prior to operation of the vehicle.

17. The vehicle of claim 15, wherein input test data inserted into the input data stream during operation of the vehicle is dynamic test data generated during operation of the vehicle.

18. The vehicle of claim 15, wherein inserting input test data into the input data stream during operation of the vehicle comprises synchronous coordination.

19. The vehicle of claim 15, wherein inserting input test data into the input data stream during operation of the vehicle comprises explicit tagging.

20. The vehicle of claim 15, wherein input test data is insert into the input data stream during operation of the vehicle at predetermined time intervals.

21. The vehicle of claim 15, wherein the neural network accelerated by a graphics processing unit is certified at an Automotive Safety Integrity Level.
